(19) United States
(12) Patent Application Publication
(10) Pub. No.: US 2009/0030729 A1
(43) Pub. Date: Jan. 29, 2009

(54) MEDICAL INFORMATION DEVICE SYSTEM

(76) Inventor: Norman L. Doyle, St. Clairsville, OH (US)

Correspondence Address: HOWARD M COHN;PATENT ATTORNEY LLC, 21625 CHAGRIN BLVD #220, CLEVELAND, OH, 44122, US

(21) Appl. No.: 12/179,089

(22) Filed: Jul. 24, 2008

Related U.S. Application Data
(60) Provisional application No. 60/951,525, filed on Jul. 24, 2007.

(51) Int. Cl. G06Q 50/00; G06Q 10/00

(52) U.S. Cl. 705/3

(57) ABSTRACT

A medical information storage device, carried on the person of a user, comprises a watch having a flash drive with a user's pertinent medical records and a USB plug adapted to project from watch. The USB plug is connected to the flash drive and adapted to connect to a medical professional's computer so that the medical professional will have access to the person's medical records.

### CROSS-REFERENCE TO RELATED APPLICATIONS

This application claims priority to U.S. Provisional Patent Application Ser. No. 60/951,525, entitled “Mediwatch System” filed Jul. 24, 2007, the disclosure of which is hereby expressly incorporated herein by reference.

### TECHNICAL FIELD OF THE INVENTION

The present invention relates generally to a medical information device system whereby an individual can carry their medical information, and more particularly to a medical information device system including a device carried by a user having their up to date medical information so that it can be accessed by a medical professional when necessary.

### BACKGROUND OF THE INVENTION

In many accident cases, it is found that the injured person does not carry current emergency medical information, or that emergency personnel cannot locate the information. This situation is caused by that fact that emergency instructions which people carry are often not readily accessible. As a result, an injured person risks receiving inappropriate or even dangerous medical treatment.

There have been various proposals for supplying personal medical information on a personal object to be worn at all times, such as on a piece of jewelry, a medal, etc., perhaps in combination with a symbol to attract attention and/or an inscription showing the individual's identity. However, all these objects have disadvantages and shortcomings which have discouraged widespread use.

In order for such an information system to be reliable and effective, it must be widely used and well known to emergency workers responding to accidents. To become well known, the objects storing the medical information must be worn by many people; that is, they must meet criteria such as convenience, effectiveness, appearance and cost. The objects must be clearly recognizable as indicators of personal medical information, but since the information is confidential, it should not be visible when the object is worn.

The current invention seeks to create a device which alleviates the aforementioned problems.

### ASPECTS AND SUMMARY OF THE INVENTION

An aspect of the present invention is to provide a medical information device storing the medical information that can be worn or carried by a user.

An aspect of the present invention is to provide a medical information device that is clearly recognizable as indicators of personal medical information.

Another aspect of the present invention is to provide a medical information device that is an indicator of personal medical information that is not visible when the object is worn.

Yet another aspect of the present invention is to provide a medical information device storing medical information that is convenient to use and carry, operates effectively, has a pleasing appearance and is of a relatively low cost.

Another aspect of the present invention is to provide a system for updating medical information carried in a medical information storing device.

Yet another aspect of the present invention is to provide a system for updating medical information on a system server from sources including hospitals, doctors offices, and medical laboratories and testing centers.

Accordingly, there has been provided a medical information storage device carried on the person of a user. The medical information storage device comprises: a watch having a flash drive with a user's pertinent medical records; and a USB plug adapted to project from the watch. The USB plug is connected to the flash drive and adapted to connect to a medical professional's computer so that the medical professional will have access to the person's medical records.

Further according to the present invention, the USB plug can be stored in the watch for ease of wearing the watch and extended out of the watch for attachment to a USB reader.

Still further according to the present invention, a medical information device system, comprises: a medical information storage device; a medical information system computer; a computer systems located in places where medical information is stored; means for sending medical information from the computer systems to the medical information system computer; and means for loading the medical information from the medical information system computer to the medical information storage device.

Also according to the present invention, the medical information storage device comprises: a watch having a flash drive with a user's pertinent medical records; and a USB plug connected to the flash drive and adapted to project from the watch, the USB plug being adapted to connect to a medical professional's computer so that the medical professional will have access to the person's medical records.

Further according to the present invention, the medical information system computer includes means for updating the flash drive with medical information relating to the person associated with the flash drive.

According to the present invention, the medical information system computer is security protected and can only be updated when connected to the computer systems located in places where medical information is stored. The medical information is stored in hospitals, medical health care centers, doctor's offices, medical laboratories, medical testing centers and medical treatment facilities. Also, the computer systems located in places where medical information is stored are secured with specific codes corresponding to codes in the medical information system computer.

Yet further according to the present invention, the means for sending medical information from the computer systems to the medical information system computer comprises streaming updated medical information for each account corresponding to the individual MISD participants on a regular basis. Moreover, means for sending medical information from medical information system computer to the individual MISDs comprises; a personal computer station for each MISD holder; means for sending medical information to the personal computer station from the system computer server; and means for synching the MISD to the personal computer station to upload new medical information to the MISD.

Also according to the present invention, the means for sending medical information from medical information system computer to the individual MISDs comprises a satellite connection between the system computer server and the computer systems located in places where medical information is stored.

According to the present invention, a method of using a MISD when the patient encounters a situation where medical personnel are forced to act comprises the steps of providing a MISD on the person of the patient: providing the MISD with a USB plug; inserting the USB plug into a corresponding outlet on a computer of the medical personnel; starting an autorun program on the medical personnel's computer causing an initial screen with a picture of the patient to pop up on a screen of the computer; checking the time of the last update of the patient's medical information stored on the MISD; and displaying current medical data of the patient on the medical professional's computer. In addition all of the vital medical information about the patient is accessed and the medical information is shown on a number of screens of the medical professional's computer.

Yet further according to the present invention, the method comprises the steps of checking the time of the last update of the patient's medical information; and downloading the most current medical data if the MISD has been recently updated; and if the most current medical data is on the MISD, downloading the data onto the medical professional's computer. However, after checking the time of the last update of the patient's medical information the MISD has not been recently updated, the medical professional's computer is connected with a medical information system server to update the medical data stored on the MISD; and the medical data is downloaded into the medical professional's computer.

Further according to the present invention, a window flashes on the first screen if the patient has a special physical condition that the medical professionals need to be immediately aware of. The first screen shows profile information including the MISD owner's picture, name, age, address, birth date, blood type, physician. Next a second screen is opened with tabs to stored information. A third screen can be opened with links to medical reports. The third screen has links to video and audio information.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is an illustration of a medical information storing device, in accordance with the present invention.

FIG. 2 is an illustration of the medical information storing device of FIG. 1 being connected to a system for updating medical information carried in a medical information storing device, in accordance with the present invention.

FIG. 3 is a flow chart of the steps needed for updating medical information carried in a medical information storing device, in accordance with the present invention.

FIG. 4 is a flow chart of the steps to use the medical information storing device, in accordance with the present invention.

FIG. 5 illustrates the information on various computer screens of a medical professional's laptop/computer, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps and materials are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

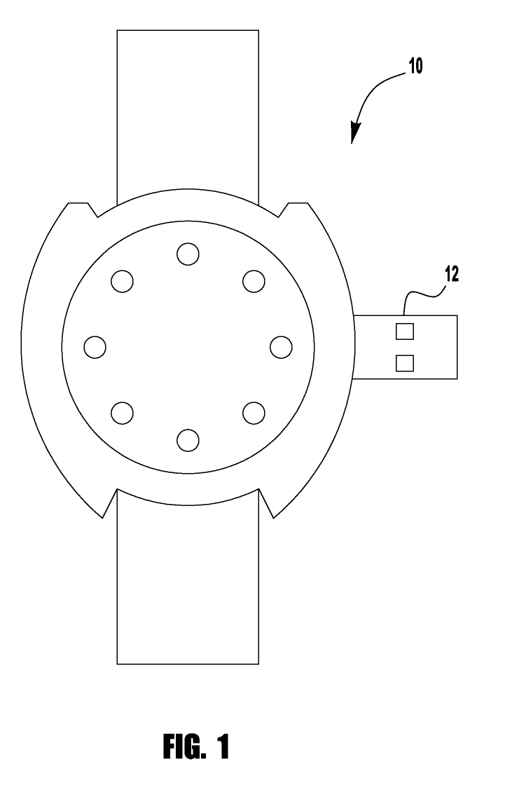

The medical information storage device (MISD) 10, as shown in FIG. 1, is an emergency management component that reduces the amount of time an emergency medical technician (EMT), paramedic or doctor needs to get medical information from a person that is sick or unable to respond to emergency personnel or doctors. It also helps to greatly increase efficiency in doctors' offices and emergency rooms and reduces mistakes in hospitals.

The medical information storage device (MISD) 10 is preferably a watch having a flash drive 12 with all of a user's pertinent medical information. The flash drive is connected to a USB plug 12 which can be stowed away in the watch and then pulled out as shown. While the MISD 10 is preferably a watch worn on a user's wrist, it is within the terms of the present invention for it to be a pendant (not shown) that can be worn, for example about a user's neck. It is within the terms of the present invention for the MISD 10 to be a key fob.

The flash drive of MISD 10 can have 1 gigabyte to 4 gigabytes of memory, with the possibility of more memory space as technology improves. This memory stores all of the owner's pertinent medical information. In the preferred embodiment, MISD 10 has a USB plug compatible with most computers. When plugged in to a computer, EMTs, paramedics, hospital staffs and/or doctors can see the medical history of the user and thereby be able to provide proper medical assistance as compared with the situation where virtually nothing is known about the patient.

It is also within the scope of the present invention for the USB plug to be replaced with a jack on the MISD that receives a plug extending from the computer used by the EMTs, paramedics, hospital staff and/or doctors.

Besides storing the wearer's past medical histories, the MISDs can also include components to monitor the user's vital signs such as for example, heart rate, pulse rate, oxygen intake, and glucose levels. Using this ability of the MISDs, doctors and medical personnel can monitor a patient irrespective of the location of the patient. Warning signals can be broadcasted by the MISDs to notify medical professionals in the event the wearer patient suffers from a heart attack, a sugar problem or some other dangerous or life threatening condition. The MISD can include a global positioning system (GPS) to locate the user in the event of an emergency and to help with Alzheimer's patients, children, pilots, military personnel, and other people that need medical help but are unable to communicate their location.

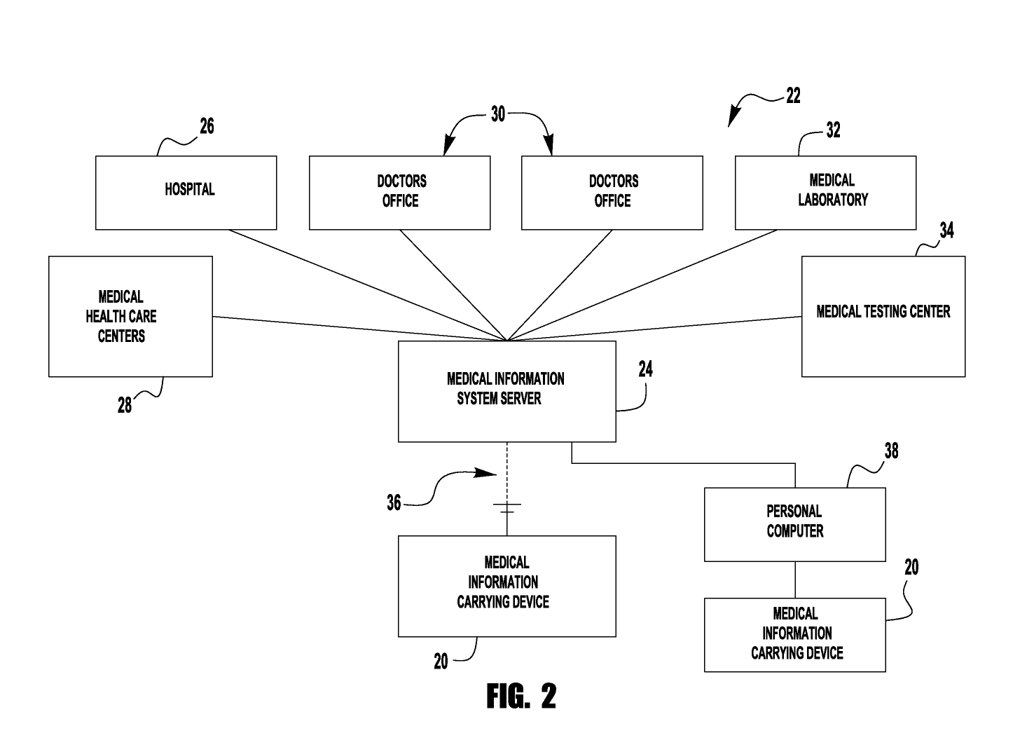

The medical information device system 22 of the present invention, as shown in FIG. 2 is designed to get a person's medical information to the appropriate medical personnel as quickly as possible. As stated hereinbefore, this is to be done by storing the user's medical information on a flash drive in a watch, pendant or key fob with a USB plug 20. Each flash drive will be security protected and can only be updated when connected to the computer servers 24 of the medical information device system 22 and/or licensed, secured computer systems located in hospitals 26, medical health care centers 28, doctor's offices 30, medical laboratories 32, medical testing centers 34 and/or other places where medical information is stored. These licensed, secured computer systems periodically contact the computer server 24 of the medical information device system 22 of the present invention and stream the updated medical information for each account corresponding to the individual MISD participants. The updated medical information can be sent to the individual MISD 20 from the medical information system computer server 24 by synching the MISD to a personal computer station 38 which in turn is connected to the computer server 24. Alternatively, the MISD can be connected to the medical information system computer server 24 via a satellite connection 36. Alternatively, MISD 20 can be updated directly at the medical location 26, 28, 30, 32, 34 where the new data is generated.

Once the records of individuals are updated on the medical information system computer server 24, the information on the individual MISD's also gets updated. In one embodiment, the MISDs are constantly updated via a satellite link 36. In another embodiment, the updates can be delivered to the user's computer 38 though e-mail or by connecting the computer 38 to the computer server 24 and the MISD can be connected through the USB plug to the computer 38 so that the new information can be downloaded into the MISD. It is also within the terms of the invention for the user to update the medical information carried in the MISD directly at the hospital, doctor's office or lab where the information is added.

The laptop/computer 38 into which the MISD 20 is connected will only be able to read the medical information after the installation of licensed data software with Health Insurance Portability and Accountability Act (HIPAA) approved encryption code. EMTs will only be able to read the medical information on the MISD while doctors, hospitals, medical laboratories, medical health care centers and medical testing centers will be authorized to add or change the data from the MISD. To accomplish the step of authorizing specific users, licensed software and hardware are initially installed in locations such as, hospitals 26, medical health care centers 28, doctor's offices 30, medical laboratories 32, medical testing centers 34 and/or other places where medical information is stored to allow communication with the medical information system server 24. The licensed software and hardware can include a security system, compatible software, and a camera to capture pictures of the patient.

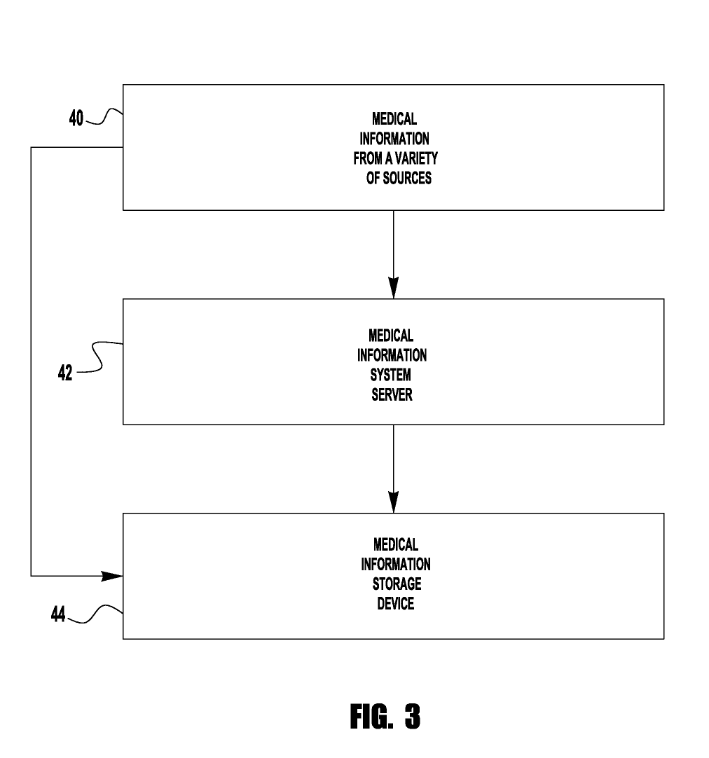

Typically, the MISD system 22 operates as shown in the flow chart of FIG. 3.

Initially, pertinent medical information from licensed, secured computer systems located in hospitals 26, medical health care centers 28, doctor's offices 30, medical laboratories 32, medical testing centers 34 and/or other places where medical information is stored, as shown in box 40, is delivered to the medical information system server 24 of the medical information device system 22, represented by box 42. The secured computer systems located in places where medical information is stored are secured with specific codes corresponding to codes in the medical information system computer.

This medical information from the medical information system server 24 shown in box 42 is delivered to the MISD, as shown in block 44 and stored thereon. Alternatively, the medical information of block 40 can be directly loaded onto the MISD as previously discussed.

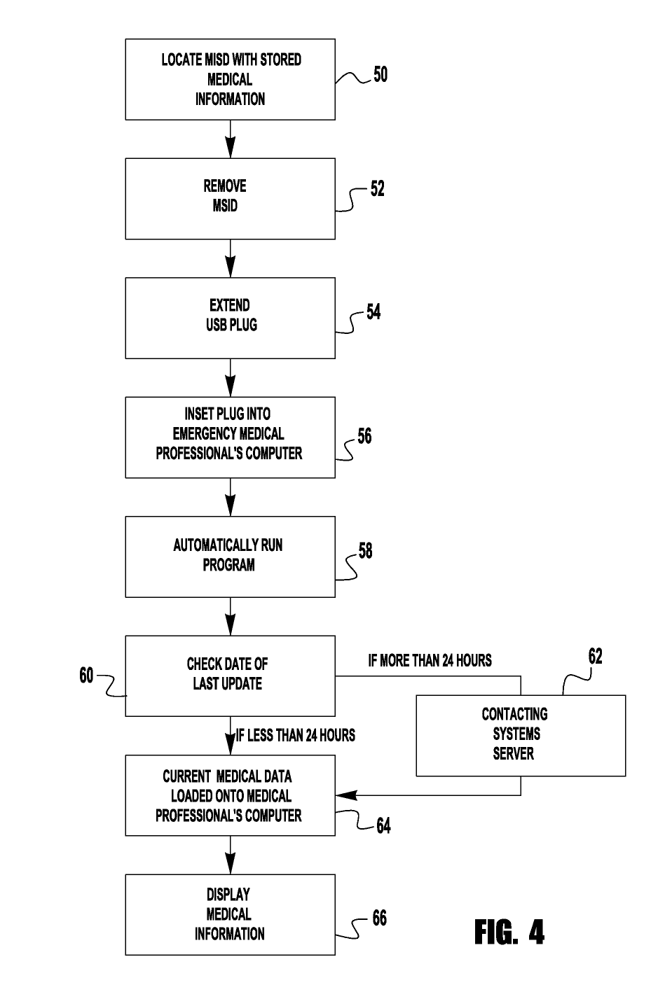

Then, as shown in FIG. 4, the series of steps needed for using the MISD when the patient encounters a situation where medical personnel are forced to act are shown in the flow diagram.

First as represented in block 50 of FIG. 4, the medical professional can locate the MISD with the stored medical information.

Next as represented by block 52, the MISD is removed by the medical professional from the patient.

Continuing, as shown in block 54, the medical professional pulls the USB plug outward from the MISD and into the data transfer position.

Next, as shown in block 56, the medical professional inserts the USB plug into a corresponding outlet on their laptop or desktop computer.

Continuing, as represented by block 58, the flash drive starts an autorun program on the medical professional's laptop or desktop computer causing an initial screen with a picture of the patient to pop up on the laptop/computer screen. The picture is provided so that the medical professionals can insure that the medical data on the MISD is for the patient being treated. At the same time, some basic information such as the patient's name, age, address, birth date, blood type, physician, etc. will appear on the computer screen with the picture. If the patient has a chronic condition that the EMTs need to be aware of immediately, a window will flash on the initial screen to be clicked causing another screen to open describing the patient's special condition.

Box 60 represents the MISD checking the time of the last update of the patient's medical information. If the MISD has been updated recently, such as within 24 hours, the most current medical data is downloaded onto the medical professional's computer as represented by box 64.

If the MISD has not recently been updated, such as longer than the last 24 hours, the medical professional's computer connects with the medical information system server, represented by box 62, to update the medical data stored on the MISD as shown in Box 64.

Continuing, the most current medical data is displayed on the medical professional's computer as represented by box 66. In that case, the program run on the medical professional's computer is ready to be used and all of the vital medical information about the patient can be accessed and shown on a number of screens of the medical professional's computer/laptop screen.

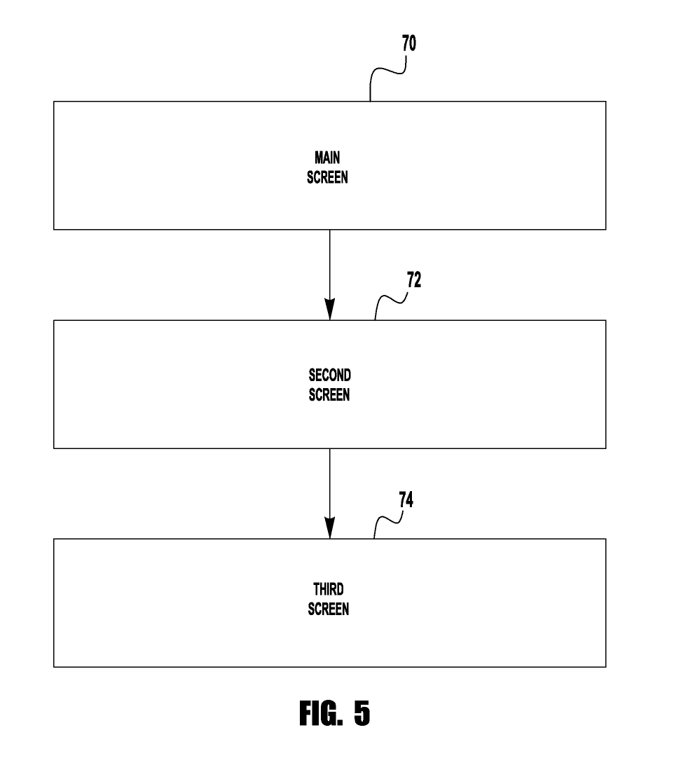

FIG. 5 illustrates the various computer screens of the laptop/computer associated with using the medical information device system 22.

Box 70 represents the main laptop/computer screen containing profile information as described earlier, such as the owner's picture, name, age, address, birth date, blood type, physician, etc. Additionally, if the patient has a chronic condition that the EMTs need to be aware of immediately, a window will flash below the picture to be clicked.

Next, a second screen is opened as represented in box 72.

On this screen there can be provided tabs to:
1. Medical Conditions—Brief description
2. Current Medications—List of names, Dosage, Frequency, Prescribed by, Pharmacy, Fill Date
3. Allergies—List of known Allergies, Type of Allergy
4. Emergency Contacts—List of Emergency Contacts, Relationship, Work Phone, Home Phone, Cell Phone
5. Insurance—List of Current Insurance Providers, Policy Numbers, Group Numbers, Effective Dates, Co Pays
6. Surgical History—List of previous Surgeries, Date, Surgeons Name & Place
7. Donor—Registered With, Registration Number, Registration Date, List of Organs, Tissues, or Full Body

From the screen represented by box 72, a third screen can be opened as represented by box 74 with links to:
Warning Notes—Same as the main screen.
Medical Reports
   A. Recent Test Results—Most recent. Note, older test results, i.e., 3rd, 4th and oldest go to archives
      1. Blood work
      2. Urine Test
      3. Phlegm Test
   B. Recent X-rays and RMI's
      1. Chest X-Ray—With links to Physicians Notes, E-Mail Physician, & PRINT
      2. Lung X-Ray—With links to Physicians Notes, E-Mail Physician, & PRINT
      3. Kidney RMI—With links to Physicians Notes, E-Mail Physician, & PRINT
      4. EKG Chart—With links to Physicians Notes, E-Mail Physician, & PRINT
      5. Medical Videos—Listing available Videos to watch and listen with links to Physicians Notes, E-Mail Physician, & PRINT
   C. Symptoms Trend Charts—All with links as above
      1. Blood Pressure Trend Chart
      2. Cholesterol Trend Chart
      3. Blood Sugar Trend Chart
   D. Patient Diet Chart—All with links as above
      1. Breakfast
      2. Lunch
      3. Dinner
      4. Permissible Snacks
   E. Family Medical History—All with links as above
      1. Father
      2. Mother
      3. Brother(s)
      4. Sister(s)
      5. Grandfather(s)
      6. Grandmother(s)
E-Mail
Print

Some links will provide video and audio information. For example, if a patient had a procedure where dye was injected, the doctor will be able to watch the dye as it flows through the patient and listen to the doctor's comments as the procedure progresses.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, systems, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A medical information storage device carried on the person of a user, the medical information storage device comprising:
a watch having a flash drive with a user's pertinent medical records; and
the watch having a USB plug projecting therefrom, the USB plug being connected to the flash drive and adapted to connect to a medical professional's computer so that the medical professional will have access to the person's medical records.

2. The medical information storage device of claim 1 wherein the USB plug can be stored in the watch for ease of wearing the watch and extended out of the watch for attachment to a USB reader.

3. A medical information device system, comprising:
a medical information storage device;
a medical information system computer;
computer systems located in places where medical information is stored;
means for sending medical information from the computer systems to the medical information system computer; and
means for loading the medical information from the medical information system computer to the medical information storage device.

4. The medical information device system of claim 3 wherein the medical information storage device comprises:
a watch having a flash drive with a user's pertinent medical records; and
a USB plug connected to the flash drive and adapted to project from the watch, the USB plug being adapted to connect to a medical professional's computer so that the medical professional will have access to the person's medical records.

5. The medical information device system of claim 3 wherein the medical information system computer includes means for updating the flash drive with medical information relating to the person associated with the flash drive.

6. The medical information device system of claim 3 wherein the medical information system computer is security protected and can only be updated when connected to the computer systems located in places where medical information is stored.

7. The medical information device system of claim 6 wherein the medical information is stored in hospitals, medical health care centers, doctor's offices, medical laboratories, medical testing centers and medical treatment facilities.

8. The medical information device system of claim 6 wherein the computer systems located in places where medical information is stored are secured with specific codes corresponding to codes in the medical information system computer.

9. The medical information device system of claim 6 wherein means for sending medical information from the computer systems to the medical information system computer comprises streaming updated medical information for each account corresponding to the individual MISD participants on a regular basis.

10. The medical information device system of claim 6 wherein means for sending medical information from medical information system computer to the individual MISDs comprises;
a personal computer station for each MISD holder;
means for sending medical information to the personal computer station from the system computer server; and
means for synching the MISD to the personal computer station to upload new medical information to the MISD.

11. The medical information device system of claim 6 wherein means for sending medical information from medical information system computer to the individual MISDs comprises;
a satellite connection between the system computer server and the computer systems located in places where medical information is stored.

12. The method of using the MISD when the patient encounters a situation where medical personnel are forced to act, comprising the steps of:
providing a MISD on the person of the patient:
providing the MISD with a USB plug;
inserting the USB plug into a corresponding outlet on a computer of the medical personnel;
starting an autorun program on the medical personnel's computer causing an initial screen with a picture of the patient to pop up on a screen of the computer;
checking the time of the last update of the patient's medical information stores on the MISD; and
displayed current medical data of the patient on the medical professional's computer.

13. The method of claim 12 further comprising the step of:
accessing all of the vital medical information about the patient and showing the medical information on a number of screens of the medical professional's computer.

14. The method of claim 12 further comprising the steps of:
checking the time of the last update of the patient's medical information; and
downloading the most current medical data if the MISD has been recently updated; and
if the most current medical data is on the MISD, downloading the data onto the medical professional's computer.

15. The method of claim 12 further comprising the steps of:
checking the time of the last update of the patient's medical information; and checking the time of the last update of the patient's medical information; and
if the MISD has not been recently updated, connecting the medical professional's computer with a medical information system server to update the medical data stored on the MISD; and
downloading the data onto the medical professional's computer.

16. The method of claim 13 further comprising the step of:
flashing a window on a first screen if the patient has a special physical condition that the medical professionals need to be immediately aware of.

17. The method of claim 13 wherein the first screen shows profile information including the MISD owner's picture, name, age, address, birth date, blood type, physician.

18. The method of claim 13 including the step of opening a second screen with tabs to stored information.

19. The method of claim 18 including the step of opening a third screen with links to medical reports.

20. The method of claim 19 including the step of opening a third screen with links to video and audio information.
